(19) United States
(12) Patent Application Publication
(10) Pub. No.: US 2016/0256818 A1
(43) Pub. Date: Sep. 8, 2016

(54) Production of electric power from fossil fuel with almost zero air pollution

(71) Applicant: Eliot Gerber, Moraga, CA (US)

(72) Inventor: Eliot Gerber, Moraga, CA (US)

(21) Appl. No.: 13/999,746

(22) Filed: Mar. 19, 2014

(51) Int. Cl. B01D 53/22; F01D 15/10; H02K 7/18; F01N 5/02; F01K 23/10

(52) U.S. Cl. CPC B01D 53/226; B01D 53/229; F01N 5/02; F01K 23/10; H02K 7/1823; F01D 15/10; B01D 2053/221; F05D 2220/72

(57) ABSTRACT

The present system produces electrical power from burning coal or natural gas, with almost zero air pollution. In its lack of air pollution is similar to air and wind power, but less costly. Its power may be produced day and night and when the wind is not blowing. Its power is less costly than nuclear power, and without the possibility of radiation damage, melt down, and log-term radiation storage.

The US tax law provides a $10 or $20 credit per ton CO2 for sequestration in “Secure geological storage”. See 26 USC §45Q. The estimated cost of this system's CO2 carbon capture is below that tax credit. The tax credit of $20/ton (large coal power station—800K tons of CO2) would generate a profit of millions of dollars.

This system's capture cost for CO2 is about the same in gas or coal plants. However, coal plants generate about 3 times the CO2 tonnage of gas plants per unit of electric power. In one example, the system uses combined cycle gas turbine-steam units (CCGT) thermal efficiency of 50-60%. CCGT exhaust gas is relatively cool and clean, with almost no particulates, nitrogen oxide, or mercury

The CO2 is separated from nitrogen (N2) using at least two cascaded stages of membrane separators. The permeance of the membranes of the first stage is at least 800 and preferably 2000-10,000. This permits low gas compression which saves the cost of larger compressors and electrical power. Also the area of the membranes are small due to their high permeance. The membranes of the second stage have a lower permeance with higher selectivity and higher pressure may be used. This does not add much to cost because the volume of gas separated is only 2-7% (gas) or 12-14% (coal) of the volume of CCGT exhaust gas. The over 90% pure separated CO2 is then compressed and sold or sequested in geological formations.

### BACKGROUND

### Present State of the Art

### Greenhouse Gas Emissions

Global warming, or the ‘greenhouse effect’ is an environmental issue that deals with the potential for global climate change due to increased levels of atmospheric ‘greenhouse gases’. Certain gases in our atmosphere regulate the amount of heat that is kept close to the earth's surface. An increase in these greenhouse gases results in increased temperatures around the globe, with many disastrous environmental effects. The Intergovernmental Panel on Climate Change (IPCC) predicts that during the 21st Century, global average temperatures are expected to rise by between 2.0 and 11.5 degrees F. One of the greenhouse gases is carbon dioxide. The volume of carbon dioxide emissions into the atmosphere is very high, particularly from the burning of fossil fuels. In the United States over 80 percent of greenhouse gas emissions is from energy related carbon dioxide. Because carbon dioxide is a high proportion of U.S. greenhouse gas emissions, reducing carbon dioxide emissions is vital to combat the greenhouse effect and global warming. The combustion of natural gas emits almost 30 percent less carbon dioxide than oil, and about 45 percent less CO2 than coal.

The U.S. Energy Information Administration (EIA) estimates that between 2015 and 2019, 96.65 gigawatts (GW) of new electrioity capacity will be added in the U.S. According to the EIA, natural gas fired electricity generation is expected to account for 80 percent of all U.S. added electricity generation capacity by 2035.

### How Coal is Converted to Electricity

Steam coal (thermal coal) is used in power stations to generate electricity. Generally, the coal is milled to a fine powder, which increases the surface area and allows it to burn more quickly. In these pulverized coal combustion (PCC) systems, the powdered coal is blown into the combustion chamber of a boiler where it is burnt at high temperature. The hot gases and heat energy produced converts water, in tubes lining the boiler, into high pressure steam, which is passed into a turbine containing thousands of propeller-like blades. The steam pushes on these blades causing the turbine shaft to rotate at high speed. A generator is mounted at one end of the turbine shaft and consists wire coils. Electricity is generated when these are rapidly rotated in a strong magnetic field. After passing through the turbine, the steam is condensed and returned to the boiler to be heated once again.

Improvements continue to be made in conventional PCC power station design and new combustion technologies are being developed. These allow more electricity to be produced from less coal—improving the thermal efficiency of the power station

### Steam Generation Units

Natural gas can be used to generate electricity in a variety of ways. The most basic natural gas-fired electric generation consists of a steam generation unit, where fossil fuels are burned in a boiler to heat water and produce steam that then turns a turbine to generate electricity. Natural gas may be used for this process. Typically, only 33 to 35 percent of the thermal energy used to generate the steam is converted into electrical energy in these types of units.

### Centralized Gas Turbines

Gas turbines and combustion engines are also used to generate electricity. In these units' hot gases from burning natural gas spins the turbine and generates electricity.

### Combined Cycle Units

Many of the new natural gas fired power plants are ‘combined-cycle’ (CCGT) units. In this generating plant, there is both a gas turbine and a steam unit. The gas turbine operates as a normal gas turbine, using the hot gases released from burning natural gas to turn a turbine and generate electricity. In combined-cycle plants, the waste heat from the gas-turbine generates steam, which generates electricity like a steam unit. Because of this efficient use of the heat energy released from the natural gas, combined-cycle plants achieve thermal efficiencies of 50 to 60 percent. Because gas turbines have low efficiency in simple cycle operation, the output produced by the steam turbine accounts for about half of the CCGT plant output. Typically each GT (Gas Turbine) has its own associated HRSG, (heat recovery steam generator a heat exchanger) and multiple HRSGs supply steam to one or more steam turbines.

Emissions from the Combustion of Natural Gas

Natural gas is the cleanest of all the fossil fuels, as evidenced in the data comparisons in the chart below. Composed primarily of methane, the main products of the combustion of natural gas are carbon dioxide and water vapor, compounds we exhale when we breathe. Coal and oil are composed of complex molecules, with a higher carbon ratio and higher nitrogen and sulfur contents. When combusted, coal and oil release higher levels of harmful emissions, including a higher ratio of carbon emissions, nitrogen oxides (Nox), and sulfur dioxide (SO2). Coal and fuel oil also release ash particles into the environment, substances that do not burn but instead are carried into the atmosphere and contribute to pollution.

### Fossil Fuel Emission Levels

### Pounds Per Billion Btu of Energy Input

| Pollutant | Natural Gas | Oil | Coal |
|---|---|---|---|
| Carbon Dioxide | 117,000 | 164,000 | 208,000 |
| Carbon Monoxide | 40 | 33 | 208 |
| Nitrogen Oxides | 92 | 448 | 457 |
| Sulfur Dioxide | 1 | 1,122 | 2,591 |
| Particulates | 7 | 84 | 2,744 |
| Mercury | 0.000 | 0.007 | 0.016 |

Source: EIA - Natural Gas Issues and Trends 1998

### Sequestration

CO2 storage methods being studied include sequestration underground in depleted coal seams, aquifers, oil fields, etc., or marine sequestration in which CO2 is pumped below the seabed. To date, all commercial CO2 post combustion capture plants use processes based on chemical absorption with a monoethanolamine (MEA) solvent. This is an expensive process using large equipment and high energy requirements. See: Flue gas clean-up from Natural Gas Combined Cycle (NGCC) power plants using an MEA scrubbing process include: Norwegian Institute of Technology (Bolland and Saether, 1992), Documents on membrane separation for flue gas; see Journal of Membrane Science: “Power plant post-combustion carbon dioxide capture: An opportunity for membranes”; Tim C. Merkel et. al (“Merkel 1”) and for gas burning plants see Merkel et. al. “Selective Exhaust Gas Recycle etc.” I & EC Research 2012 pg. 1150 (“Merkel 2”).

### Concentration of Exhaust Gas

As gas turbines are based on heat expansion of compressed air, combustion gases makes up only a small portion of the exhaust gas from the turbine. Therefore, the CO2 concentration (3 to 6%) and CO2 partial pressure (0.03 to 0.04 bar) in the flue gas is much lower than in thermal power plants (12 to 14% concentration and 0.12 to 0.14 bar partial pressure).

### BRIEF DESCRIPTION OF THE DRAWING

FIGS. 1 and 3 are schematic drawings showing the equipment and process flow for the system and method and FIG. 2 shows that the present system is above Robeson's upper bound.

### DESCRIPTION

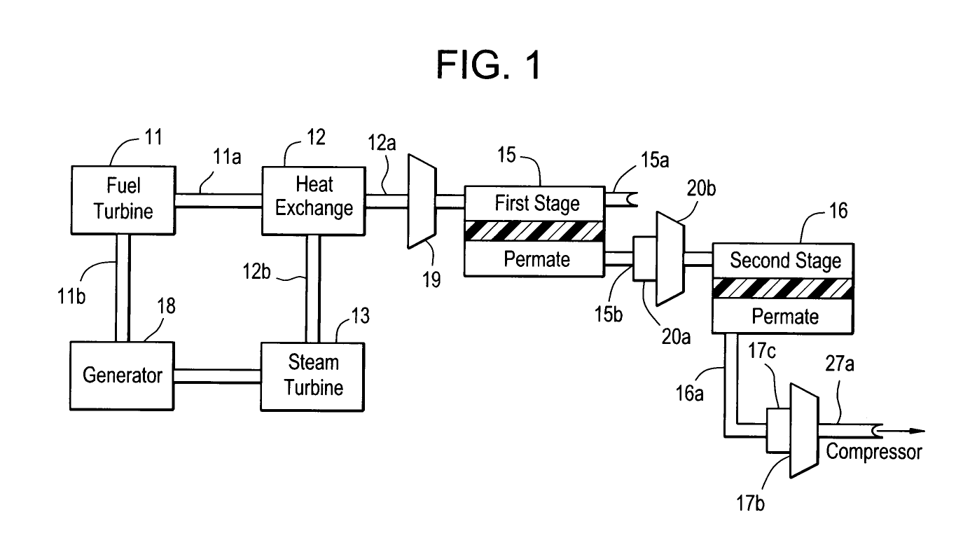

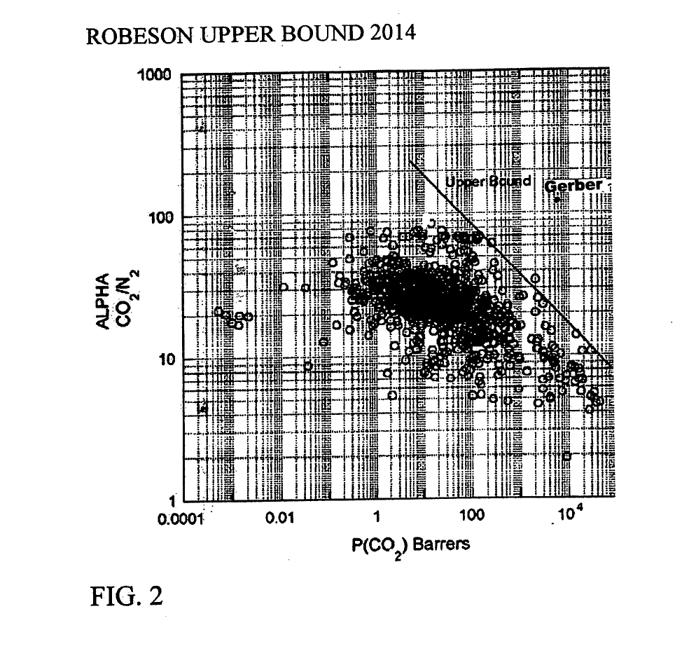

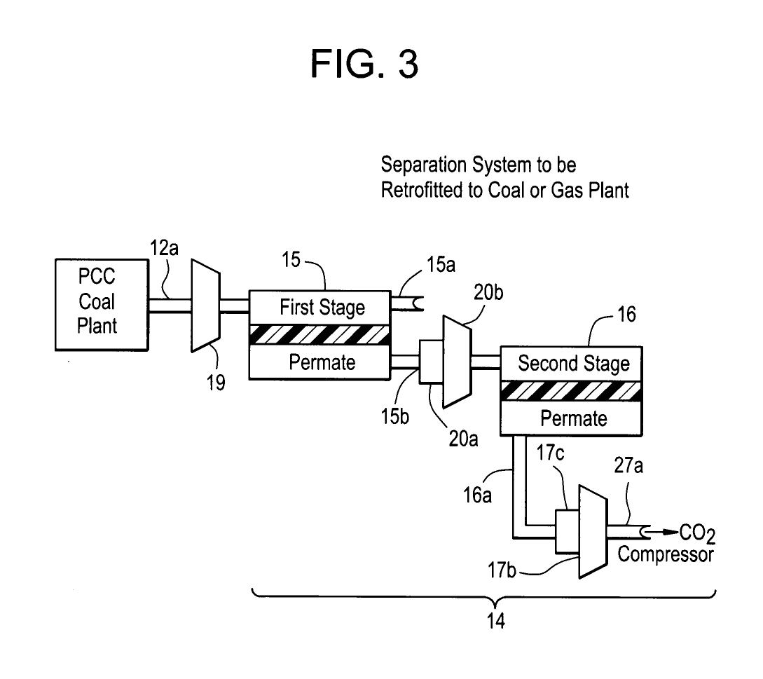

As shown in FIG. 1, a combined cycle electrical generating plant 10 consists of a natural gas fueled turbine 11 and a heat exchange boiler 12 (HRSG). The boiler produces steam which powers a steam turbine 13. The two turbines 11 and 13 may have a common shaft connected to an electrical generator 18. These components are conventional and comprise a combined cycle gas turbine (CCGT) plant 10.

The exhaust gas from the boiler 12 is generally released to the atmosphere.

That exhaust gas contains 2-4% (gas) or 12-14% (coal) of CO2, which is a harmful pollutant. In the system of FIG. 1 that exhaust gas, by blower/compressor 19, is to piped to a separation process 14. Process 14 includes a first stage of membrane separators 15 whose permeate (90-99% CO2) is piped to by vacuum pump 20a and compressor 20b to the second stage 16 of membrane separators. The permeate gas from the second stage 16 is piped to vacuum pump 17c and compressor 17b, which compresses the CO2 for shipment or sale. The means to transport the various gases are conventional pipes (tubes). They are pipe 11a from turbine 11 to boiler 12, exhaust gas pipe 12a from boiler 12 to first stage 15, steam pipe 12b from boiler 12 to steam turbine 13, pipe 15a from first stage 15 to atmosphere, permate pipe 15b from first stage to second stage 16, permeate pipe 16a from second stage 16 to compressor 17 and pipe 17a from compressor 17 to sequestration or sale. The drive shafts are 11b from the gas turbine and 13b from the steam turbine (both to the generator 18).

The volume of gas compressed by compressor 19 is all the exhaust gas from heat exchanger 12. It is a large compressor or blower. However the required compression is relatively low, 0.1-1-3 bar, so the electrical power it uses is also relatively low (pressure ratio to permeate). The second compressor 20a acts on a smaller volume of gas (2-4% or 12-14%) of the volume acted on by the first compressor. It uses higher compression (5-15 bars). The first stage membrane has a high permeance (greater than 800) and low CO2/N2-selectivity (10-100, preferably 10-30). In the second stage the pressure is greater (6-15) bar and the membrane has a lower permeance (10-50) and higher CO2/N2 selectivity (greater than 20 and preferably over 100).

### Membrane Permeance and Selectivity

The membranes used in the first stage have a permeance of at least 800 and preferably over 2000 and most preferably over 4000. This is an important feature of the system for a number of reasons:

1. The higher the permeance the less may be the area of membrane that is used. The same gas flow is obtainable, for carbon dioxide (CO2), with a membrane of permeance for CO2 of 100 and membrane area of 100 m2 and a membrane of permeance for CO2 of 1000 and membrane area of 10 m2.
2. The lower the area of the membrane the less the cost of its installation. A smaller membrane area means less cost due the cost of the membrane and lower costs of its supports (modules and skids). The selectivity of the membrane of the first stage may be as low as 10 (selectivity CO2/N2).
3. The high permeance permits lower compression (blower) pressure. The volume of exhaust gas blown into the first stage is large. The membranes of the first stage separate all the exhaust gas from the boiler. The lower pressure means a smaller compressor (blower) may be used. Also the power used may be less. For example raising the permeance from 200 to 400 means that the required pressure may be reduced, the compressor may be ½ the size and only ½ power used. In the present system the preferred permeance for the first stage membranes is over 2000 and most preferred is over 4000.

The first separation stage, because it uses high permeance membranes, requires only a small membrane area and a small “footprint” (fewer modules) and less area for modules. The membranes of the second separator stage should have selectivity which is higher than the first set of membranes, preferably selectivity of at least 20 and most preferably 50-1000. The volume of gas processed through the second stage is only a small portion of the volume of exhaust gas processed by the first stage. The second stage may have a higher compression and still be low in cost since the volume of gas is low. This higher compression permits membranes having lower permeance i.e 30 and higher selectivity (50-1000). All of the membranes are preferably enclosed in spiral wound membrane modules. Such modules are strong, resist fouling, and economical.

### Membranes for the First Separation Stage

The following are three examples of membranes which appear to be suitable for the first separation stage. At this time only the first example appears to be commercially available.

1. MTR “Polaris 3” membrane. Membrane Technology and Research Inc. (MTR Newark, Calif.) tested a CO2 separation and capture system using its MTR “Polaris” 1 membrane with a coal gasification exhaust flume. The Polaris™ membrane system is said to use a CO2-selective polymeric membrane (micro-porous films which act as semi-permanent barriers to separate two different mediums). The membrane material is formed into modules and captures CO2 from a plant's flue gas. See Journal of Membrane Science: “Power plant post-combustion carbon dioxide capture: An opportunity for membranes”; Tim C. Merkel et. al. The permeance of Polaris 3 may be 2000-4000.
2. Zeolites and especially “SAPO-34”. Zeolites are aluminosilicate members microporous solids known as “molecular sieves.” The term molecular sieve refers to a particular property of these materials, i.e., the ability to selectively sort molecules based primarily on a size exclusion process. This is due to a very regular pore structure of molecular dimensions. The maximum size of the molecular or ionic species that can enter the pores of a zeolite is controlled by the dimensions of the channels. These are conventionally defined by the ring size of the aperture, where, for example, the term “8-ring” refers to a closed loop that is built from eight tetrahedrally coordinated silicon (or aluminium) atoms and 8 oxygen atoms.

SAPO-34 is a crystalline molecular sieve with 0.38 nm pores that can be grown as thin continuous layers on the inside of porous ceramic tubes to form a membrane. See: Michael Chen “The Effects of Operating Conditions on Gas Transport Mechanisms through SAPO-34 Zeolite”. And see: “High-Flux SAPO-34 Membrane for CO2/N2 Separation” Shiguang Li and Chinbay Q. Fan; Ind. Eng. Chem. Res., 2010, 49 (9), pp 4399-4404. “a CO2 permeance of 1.2×10-6 mol/m2·s·Pa (=3500 GPU) with a CO2/N2 separation selectivity of 32 for a 50/50 feed at 22° C. At a feed pressure of 2.3 MPa (23 bar), the CO2 flux was as high as 75 kg/m2 h.” Also see U.S. Pat. No. 8,409,326 “High flux and selectivity SAPO-34 membranes for CO2/CH4 separations” Shiguang Li.

3. Poly(trimethylene terephthalate)-block-poly(ethylene oxide) (PTT-b-PEO) copolymers as CO2-philic membrane materials. Synthesized optimal materials with promising CO2 separation performance (CO2 permeability=183-200 Barrer and CO2/N2 selectivity >50). See: Yave, W. et al. “CO2-philic polymer membrane with extremely high separation performance” Macromolecules, 43 (1) (2010), 326-333. The permeances are said to be extremely high, i e. >5 m3 (STP) m-1 h-1 bar—because the membranes are made from a CO2 philic polymer material and they are only a few tens of nanometers thin. See GMT (Germany) (GMT Membrantechnik GmbH; Am Rhein 5•D-79618 Rheinfelden).
4. A class of thin film composite (TFC) membranes, consisting of a high molecular weight amorphous poly(ethylene oxide)/poly(ether-block-amide) (HMA-PEO/Pebax_2533) selective layer and a highly permeable polydimethylsiloxane (PDMS) Intermediate layer which was pre-coated onto a polyacrylonitrile (PAN) microporous substrate. In contrast to the performance of conventional materials, the selective layer of TFC membranes shows super-permeable characteristics and outstanding CO2 separation performance. A CO2 permeance of 2000 GPU and a CO2/N2 selectivity of 40. This result arises from the introduction of HMA-PEOs into the Pebax_2533 matrix, leading to high CO2 permeability and flux. “Highly permeable membrane materials for CO2 capture” Qiang Fu et. al. J. Mater. Chem. A, 2013, 1, 13769
5. Polymer of intrinsic microporosity PIM-1 having a CO2 barrier of 5500 gpu and a barrier of 398 for N2. PIM-1 was prepared from 5,5_,6,6_-tetrahydroxy-3,3,3_,3_-tetramethyl-1,1_-spirobisindane and tetrafluoroterephthalonitrile. See Budd P M et al. Journal of Membrane science 2005:251:263e9. “Gas separation membranes from polymers of intrinsic microporosity” and US Pat. Appl. 20120264589 & 2013/0145931.
6. MgMOF-74 membranes:
“CO2/N2 permeation selectivities with MgMOF-74 membranes at pt0>1 MPa are about a factor two higher than those reported for SAPO-34 and DDR membranes. An important advantage of MgMOF-74 membranes is that due to the 1.1 nm channel sizes, the permeances are more than two orders of magnitude higher than for SAPO-34 and DDR membranes. “Rajamani Krishna et. al. “investigating the potential of MgMOF-74 membranes for CO2 capture” J. Mem. Sci. 377 (2011) 249-260

Most preferably, in the first stage, the membranes have a permeance of 2000-10,000 for CO2. The driving force across a gas-separation membrane is the pressure differential between the feed side and the permeate side. Creating this driving force accounts for most of the cost for membrane separation since flue gases are at or slightly above atmospheric pressure. It is conventional to compress the feed gas to a higher pressure (15 to 20 bar) and set the permeate stream at atmospheric pressure (designated as pressurized feed/atmospheric permeate mode). Under this mode, the feed-gas and the post-separation compressors account for over 50% of the capital and operating costs. To reduce the cost of compressing, the present approach is to compress the feed gas at the first stage, at a lower pressure i.e. 0.1 to 1.1 bar.

The first separation stage, because it uses high permeance membranes, requires only a small membrane area and a small “footprint” (fewer modules and less area for modules). The membranes of the second separator stage should have selectivity which is higher than the first stage of membranes, preferably selectivity of at least 20 and most preferably 40-200. The volume of exhaust gas processed through the first stage and transported to the second stage is mostly CO2. The first stage cuts out over 85 percent of the total volume of the exhaust from the plant and releases it to the atmosphere (gas plant). The second stage's volume is that remaining percent. The second stage has a higher compression and is low in cost since the volume of gas is low. This higher compression permits membranes having lower permeance i.e. 20-100 and higher selectivity (20-1000) and preferably above 30.

### Membranes for the Second Separation Stage

Following examples of membranes suitable for the second separation stage:

1. MTR “Polaris 1” membrane from Membrane Technology and Research Inc. (MTR Newark, Calif.). Polaris 1 has a lower permeance, of 1000, and a higher selectivity of 50 compared to Polaris 3. The volume of gas which passes through the first stage and is processed by the second stage is only a small part of original exhaust gas volume. The compressor (blower) size and its running electrical power for the second stage may be ⅙ the compressor size and power of the first stage. Due to the high separation property of the second stage membrane the resulting purity of the final CO2 is 98%-99.9%.
2. Shuhong Duan et al. “PAMAM dendrimer composite membrane for CO2 separation: addition of hyaluronic acid in gutter layer and application of novel hydroxyl PAMAM dendrimer”; Desalination 234 (2008) 278-285. A composite membrane prepared with a novel hydroxyl PAMAM dendrimer in the CTS-HA(20) gutter layer exhibited an “excellent CO2/N2 selectivity of 230 and a CO2 permeance of 4.6×10-7 m3 (STP) m-2 s-1 kPa-1 (=61 GPU).”
3. The polymer PMDA-pDDS/PEO4(80) mentioned in M. Yoshino, K. Ito, H. Kita, K.-I. Okamoto, “Effects of hard-segment polymers on CO2/N2 gas-separation properties of poly(ethylene oxide)-segmented copolymers”, J. Polym. Sci. Part B: Polym. Phys. 38 (2000) 170. The polymer PMDA-pDDS/PEO4(80) is said to exhibit a CO2 permeability of 238 barrer and a CO2/N2 selectivity of 49.

### Incentives for Capturing and Sequestration of CO2

U S tax law, 26 USC §45Q, provides a $10 or $20 credit per ton CO2 for geological sequestration. The amount of the credit depends on the type of storage. Emissions trading (“cap and trade”) is a market-based system to reduce air pollution by paying money for reductions in emissions. A government sets a limit (cap) on the volume of a pollutant that may be emitted. This cap is allocated or sold to firms (“emissions permits”) giving the right to emit a specific volume of the pollutant. Firms may buy permits from others. Firms in jurisdictions having a cap and trade law, which install the present system, may off-set their cost by selling emission permits. At present about 34 countries, including European countries and Australia, and some USA states, including California, have a cap and trade law.

This Separation System Retrofitted to a Coal Fueled Electric Plant would be Highly Profitable for a USA Utility

The most common type of coal burning plant is Pulverized Coal with Flue Gas Desulphurization (PC/FGD).

This is an application of post-combustion CO2 capture to the flue gas from coal burning power generating plants. The CO2 content is about 13% of the flue gas i.e. 11,000 ton CO2 per day. The flue gas is at atmospheric pressure. The flue gas contains other pollutents, see page 7. Presently SO2 and particulate matter is removed before the flue gas is vented to the atmosphere. The first stage uses a blower 19, a vacuum pump 20a, a compressor 20b, a second vacuum pump 17c, a compressor 17b and a membrane area of 0.55 MM×10 6 m2. Merkel 1 assumes a membrane of CO2 permeance of 1000 gpu. If that permeance is increased to 5500 (Zeolites and especially “SAPO-34”) the area would be only 0.55 MM×10 6 m2. At $50 per m2 its cost would be 27.5 million dollars.

If a different membrane is used, namely “Polaris 3” from Membrane Technology, having 4000 gpu; the area of the membrane would be about 0.76 MM×10.6 m2 and the cost would be about $38 million. This is $7.6 million per year (5 year level depreciation). This is only 2.1 million dollars yearly different from the results with the higher (5500 gpu) membrane suggested below.

The first blower 19 must blow all the exhaust fumes, for example 500 M3/s 1,8000,000 CMH-1,059,000 CFM). It is suggested that five blowers be used, four on line all the time (8750 hours/year) and one in reserve. The preferred blowers are rated at 291,400 CFM each, and are preferably airfoil centrifugal fans 89 inch wheel diameter and 11 HP, 0.1 Bar. Their cost is about 0.65 million each (about 2.6 million for 4). Their total running cost is about $12,000 per year. This type of fan is available from Twin City, Minneapolis, Minn. (model BCS). It would seem less costly to obtain a desired pressure ratio by a vacuum at the first stage, using a fan with little compression, then to use a compressor for all the exhaust gas. The volume of gas separated by the first stage is only about 13% of the volume of the exhaust gas. For an analysis of using a vacuum for the first stage see Ho et. al. cited below. Alternatively, although not yet tested, to obtain a compression power of 1 bar one may use large fans, of the type used in wind tunnels. For example, two fans rated at 2000 kW (total), cost about 2 million, running cost $700,000 per year. (Witt & Sohn, Germany). Another alternative is a two-stage fan (FlaktWoods).

The vacuum pump 20a is preferably a group of booster vacuum pumps, such as ten Tuthill M-D Model 1248 using a 200 HP motor. The total cost is estimated at 1.1 million dollars and yearly running cost would be about 1.3 million dollars. It acts upon the CO2 gas from stage one which is about 138,000 CFM with a vacuum of 100 torr (0.13 Bar).

That gas, about 135 CFM, is then compressed, by compressor 20b to preferably 14 Bar (203 psia). Compressor 20b may be a centrifugal compressor, such as GE type D (0.9 bar inlet vacuum). It would cost about 4 million dollars and be driven by a 8,000 HP motor whose running cost per year would be about 5 million dollars.

The permate from the second stage is about 138,000 CFM. It is acted upon by the same type of devices as the devices after the first stage. That is; the gas is pulled by vacuum booster pump 17c, which is the same type as booster pump 20a, to obtain a vacuum of 100 torr. It acts upon the CO2 gas from stage two and that gas is then compressed by compressor 17b to 14 Bar for transport or sale.

Using a 5 year level depreciation of the membrane cost of 27.5 million and 10 year level depreciation of other original costs (including building, pipes etc.) of 40 million and 25 million per year running costs (including power, labor etc.) the total yearly cost would be about 34.5 million dollars.

However, the CO2 captured and sequested would be 11,000 tons/day×365=4.0 million tons/yr×$20/ton tax credit=$80 million/yr. In US that 24.5 million of costs has a value of about 8.5 million dollars (35% Federal rate). The total of the tax credit 80 million and the value of the tax deduction is 85.5 million, which is above the yearly costs of 34.5 million cost, including transport and sequestration

The cost of carbon capture alone is about $8.6/ton. Even with an additional cost of $9/ton for further treatment of the CO2 the total cost of about $17.6 a ton is less than the amount received of about $21.5/ton. A profit of about 5 million dollars per year for the carbon capture and sequestration.

Cost of this Separation System Retrofitted to a Gas Burning Plant

Without recirculation the cost figures, for the gas plant, for the compressors and vacuum pumps, and their running costs, would be about 31% of their costs for the coal plant.

The following cost estimates show that the cost of obtaining almost zero pollution from natural gas fueled electric plants is low. The advertisement value and good will of zero pollution justifies its cost.

The cost estimates, in some instances, are derived from the T. Merkel papers cited above.

The costs relating to a 600 MW gas plant are as follows:

The vacuum pumps 17c,20a each need only move gas at 42,000 CFM. The 2 compressors 20b,17b should have a cost of $350,000 each and a running cost each of about 1.5 million each. However, preferably the compressor 17b compresses the gas to 14 bar (203 psi) which is below its final compression.

Using a level 5 year depreciation of 27.5 million membrane cost and 10 year level depreciation of other original costs (including building, pipes etc.) of about 14 million and 7 million per year running costs (including power, labor etc.) the total yearly cost would be 19 million dollars. In the gas plant, the tons of CO2 captured per year would be at least 1.23 million tons of CO2 for a tax credit (USA) of 24.6 million. In addition, the 19 million of costs is a deduction for tax purposes. In US that 19 million of costs has a value of about 6.6 million dollars (35% rate), without consideration of state corporate income tax.—for example California rate is 8.8% and New York is 7.1%. The total of the tax credit and value of the 6.6 million Federal tax deduction is 31.2 million, which is more than the costs of 21 million. This is a profit of about 10 million dollars.

The European cap-and-trade system had a decline in allowance spot prices from over $25 per metric ton of carbon dioxide (June 2008) to about $3 (May 2013). However, even at $3 per ton the utility of this example could receive 3.7 million for its sale of credits. Its net cost per year would be about 15.3 million dollars, without any tax credit. It should be able to be recover that cost in a rate adjustment. For a large electrical utility this would be about 3% of its generating plant cost, a small price to pay for helping save the planet.

The tax law, in the USA, provides a $20 credit per ton CO2. See 26 USC §45Q-Credit for carbon dioxide sequestration. This cost figures above include an average of the costs of transportation of liquid CO2 and the costs of pumping it into oil/gas fields, CO2 pipelines or of geological storage. Those costs depend primarily upon location of the plant.

### Minimum Theoretical Energy Requirement

Under the laws of thermodynamics there is a minimum theoretical energy requirement for the separation of the CO2 from the flue gas. In the flue gas from a coal-burning power plant, the CO2 concentration is ˜13 mol %. According to one calculation, although not others, the minimum theoretical energy requirement is ˜5% of the output of the coal power plant, see Guest Blog “Post-Combustion CO₂ Capture to Mitigate Climate Change: Separation Costs Energy” Cory Simon, Mar. 7, 2013. For a gas burning plant the CO2 concentration is 3-4% (assuming 4%), if that calculation is correct, the minimum theoretical energy requirement is about 11% of the output of the gas power plant. That concentration can be raised to 13% (from 4%) using “exhaust gas recycle EGR”. In EGR a portion of the exhaust gas is sent to the gas turbine. See footnotes 22-25 of Merkel 2. If the concentration of CO2 is raised to 13% the energy requirement would be reduced to 5%.

The EGR process does not take much energy, however the membrane area of the second stage would have to be increased and a larger compressor used in the second stage. However, according to Herzog et. al. “Advanced Post-Combustion CO2 Capture” April, 2009: “The minimum work of separation (for 90% capture)=43 kWh/t CO2 captured”. At $0.04 kWh this is only $1.72/t CO2. At 125 kWh/ton for 90% removal (CO2 at 5% in flue gas and $0.04 kWh)=$5/ton. In the example above, of a coal burning plant (Pgs. 16-19), generating 4 million tons/yr of CO2, the minimum work of separation, even at 125 kWh/ton, would be only 20 million dollars, well below the 85.5 million in tax credits etc.

The article “Availability analysis of post-combustion carbon capture systems: minimum work input” McGlashan and Marquis, Proc. Inst. Mech. Eng. Part C: J. Mech. Eng. Science 2007 221:1057 states; “Indeed, in principle, carbon capture is theoretically possible without any external work input for fuels of low carbon/hydrogen ratio such as heavy fuel oil and natural gas.” . . . “a flue gas CO2 concentration of 11 percent, the resulting reduction in station output is a manageable 1.34 percentage points.”

See also: See: “Post-combustion Carbon Capture with a Gas Separation Membrane: Parametric Study, Capture Cost, and Energy Analysis”, Xianqpinq Zhanq et. al. Energy fuels, 2013, 27 (8), pp 4137-4149

In the cost section above the membrane area is assumed to be 0.02 MM m2. With EGR that membrane area would be 0.07 MM m2. This is an additional cost of 3.5 million dollars.

This separation system may be retro-fitted and adapted to gas fueled steam generation units, centralized gas turbines, and combined cycle units.

### Cost of Compressing and Sequestration of CO2

CCS systems must compress CO₂ to a supercritical state for transportation and/or storage. Storage pressure local to the power plant will require a nominal 1,600 psia, while the current pipeline specification is 2,215 psia.

Ramgen Power Systems reports it is developing a high-efficiency gas compressor shock compression technology which may greatly reduce the cost of compression.

In a 2006 study the cost of compression to a liquid and transportation was estimated at $10 a ton. See: McCollum, Ogden “Techno-Economic Models for Carbon Dioxide Compression, Transport, and Storage” UC-Davis. The cost figure of $9/ton is used above, as the compressor after the second stage compresses the gas to 203 psi.

### Capture of Particulate Matter (PM)

A fabric filter is often used to collect PM on the surfaces of fabric bags. Most of the particles are captured on already collected particles that have formed a dust layer. The fabric material itself can capture particles that have penetrated the dust layers. According to EPA, a fabric filter on a coal-fired power plant can capture up to 99.9 percent of total particulate emissions and 99.0 to 99.8 percent of PM 2.5. Thirty-five percent of coal-fired power plants in the U.S. have already installed fabric filters, according to environmental Health and Engineering. The blower 19, in FIG. 1, can be used to blow exhaust gas to the fabric bags (“bag house”). In that way the PM will not clog or foul the first stage membrane.

The articles and patents cited above are incorporated by reference herein, as are the following references of interest: Minh T Ho et. al. “Reducing the Cost of CO2 Capture from Flue Gases Using Membrane Technology” Ind. Eng. Chem. Res. 2008, 47, 1562-1568; Li Zhao et. al. “Cascaded Membrane Processes for Post-Combustion CO2 Capture”, Chem. Eng. Technology 2012, 35, No. 3, 489-496: Qiang Fu et. al. “Highly permeable membrane materials for CO2 capture”, J. Mater. Chem. A 2013, 1, 13769-13778. Edward Rubin et. al. “The Cost of Carbon Capture and Storage for Natural Gas Combined Cycle Power Plants” Environ. Sci. Technol. 2012, 46, 3076-3084.

The cost or capture of CO2, in a coal or gas facility, is way below the costs projected by others. This is because the system is far above Robeson's upper bound.

What is claimed is:

1. A system for the separation and non-polluting disposal of carbon dioxide derived from the exhaust of burning fossil fuel, including a gas separation system which includes: a first stage of gas membranes CO2 separators, means to transport exhaust gas to the first stage, the first stage separating CO2 from other gases in the exhaust gas, a second stage of gas membrane CO2 separators, means to transport permeant gas that passes through the membranes of the first stage to the second stage, the second stage producing CO2 permeate gas (that passes through the membranes of the second stage) of purity greater than 90%, a CO2s gas compressor, and means to transport the permeate gas that passes through the second stage to the compressor,
wherein: the membranes of the first stage have a permeance greater than 800 GPU and a CO2/N2 selectivity of greater than 10 and the membranes of second stage have a permeance greater than 10 GPU and a CO2/N2 selectivity greater than 30.

2. A system as in claim 1 wherein the membranes of the first stage have a permeance of at least 4000 GPU.

3. A system as in claim 1 wherein the membranes of the second stage have a selectivity for CO2 greater than 100.

4. A system as in claim 1 and also including a first blower to compress gas entering the first stage and a second stage compressor to compress gas entering the second stage, wherein in operation the gas is compressed at a lower pressure by the blower than by the compressor.

5. A method for the separation and non-polluting disposal of carbon dioxide in the exhaust from the burning of fossil fuel, including a gas separation method which includes: separating the CO2 from N2 using a first stage of gas membrane CO2 separators, transporting exhaust gas to the first stage of gas membrane CO2 separators, transporting permeant gas that passes through the first stage to a second stage of gas membrane CO2 separators, the second stage producing CO2 permeate gas (that passes through the second stage) of purity greater than 90%, a CO2 gas compressor, and transporting permeate gas that passes through the second stage to the compressor, wherein the membranes of the first stage have a permeance greater than 800 GPU and a CO2/N2 selectivity of greater than 10 and the membranes of the second stage have a permeance greater than 10 GPU and a CO2/N2 selectivity greater than 30.

6. A method as in claim 5 wherein the membranes of the first stage have a permeance greater than 4000 GPU.

7. A method as in claim 5 wherein the membrane of the second stage has a selectivity for CO2 greater than 100.

8. A method as in claim 5 and also including a first stage blower
to compress gas entering the first stage and a second stage compressor
to compress gas entering the second stage, wherein in operation compressing gas to a lower pressure by the blower than compressing gas by the compressor.

9. A system for the production of electrical energy from natural gas fuel with the separation and non-polluting disposal of carbon dioxide, the system including a combined cycle electrical generating plant, said plant including a natural gas fueled turbine, a heat exchange boiler (HRSG) producing steam and exhaust gas containing carbon dioxide (CO2), means to transport the exhaust gas from the gas fueled turbine to the heat exchange boiler (HRSG), a steam turbine, means to transport steam from the heat exchange boiler to the steam turbine, and an electrical generator, wherein the generator is connected to and driven by both the steam and gas fueled turbines, the system also including a gas separation sub-system which includes:
a first stage of gas membrane CO2 separators, means to transport exhaust gas from the heat exchange boiler to the first stage, the first stage separating CO2 from other gases in the exhaust gas received from the heat exchange boiler, a second stage of gas membrane CO2 separators, means to transport permeant gas that passes through the first stage membrane separators to the second stage, the second stage producing CO2 permeate gas (that passes through the second stage) of purity greater than 90%, a CO2 gas compressor, and means to transport permeate gas that passes through the second stage to the compressor, wherein:
the membrane of the first stage has a permeance greater than 800 GPU and CO2/N2 selectivity of 10-100 and the membrane of the second stage has a permeance greater than 10 GPU and a CO2/N2 selectivity greater than 30.

10. A system as in claim 9 wherein the membrane of the first stage has a permeance greater than 4000 GPU.

11. A system as in claim 9 wherein the membrane of the second stage has a selectivity for CO2 greater than 100.

12. A system as in claim 9 and also including a first stage compressor
to compress gas entering the first stage and a second stage compressor
to compress gas entering the second stage, wherein in operation the gas is compressed at a lower pressure by the first compressor than by the second compressor.

13. A method as in claim 5 for the production of electrical energy from natural gas fuel with the separation and non-polluting disposal of carbon dioxide, the method including producing electrical power from a combined cycle electrical generating plant, said plant including a natural gas fueled turbine, a heat exchange boiler (HRSG) producing steam and exhaust gas containing carbon dioxide (CO2), transporting the exhaust gas from the gas fueled turbine to the heat exchange boiler (HRSG), a steam turbine, transporting steam from the heat exchange boiler to the steam turbine, and an electrical generator,
wherein the driving the generator by both the steam and gas fueled turbines; the process including transporting the exhaust gas from the heat exchange boiler to a gas separation sub-system which includes: a first stage and a second stage of gas membrane CO2 separators; in the first stage passing CO2 from the exhaust gas through a membrane having a permeance greater than 800 GPU and a CO2/N2 selectivity of 10-100 to separate CO2 from other gases in the exhaust gas,
transporting permeate gas that passes through the first stage membrane separators to the second stage membrane having a permeance greater than 50 GPU and CO2/N2 selectivity greater than 30, in the second stage producing CO2 permeate gas (that passes through the second stage) of purity greater than 90% and transporting said permeate gas from the second stage to a CO2 gas compressor to compress CO2 for sale or sequestration.

14. A process as in claim 13 wherein the membrane of the first stage has a permeance greater than 4000 GPU.

15. A process as in claim 13 wherein the membrane of the second stage has a selectivity for CO2 greater than 200.

16. A process as in claim 13 and also including a first stage compressor
to compress gas entering the first stage and a second stage compressor
to compress gas entering the second stage, wherein in operation compressing gas to a lower pressure by the first compressor than compressing gas by the second compressor.
